(19) United States
(12) Patent Application Publication
(10) Pub. No.: US 2012/0164508 A1
(43) Pub. Date: Jun. 28, 2012

(54) BATTERY PACK APPARATUS

(76) Inventors: Gary P. Houchin-Miller, Milwaukee, WI (US); Steven J. Wood, Shorewood, WI (US); Thomas J. Dougherty, Waukesha, WI (US)

(21) Appl. No.: 13/339,141

(22) Filed: Dec. 28, 2011

Related U.S. Application Data
(63) Continuation of application No. PCT/US2010/040656, filed on Jun. 30, 2010.
(60) Provisional application No. 61/222,461, filed on Jul. 1, 2009.

(51) Int. Cl. H01M 10/50

(52) U.S. Cl. 429/120

(57) ABSTRACT

A battery system for use in a vehicle is configured to provide at least a portion of the propulsion power for the vehicle and includes a plurality of battery modules. Each battery module includes a plurality of electrochemical cells configured to store an electrical charge. The battery system also includes a plurality of fan assemblies each having a motor and at least one fan blade. Each fan assembly is associated with one of the plurality of battery modules to regulate the temperature thereof. A first fan assembly of the plurality of fan assemblies has a different configuration than at least one of the other of the plurality of fan assemblies or is configured to provide an output that is different from an output provided by at least one of the other of the plurality of fan assemblies.

### CROSS-REFERENCE TO RELATED PATENT APPLICATIONS

This application is a continuation of International Patent Application No. PCT/US2010/040656, filed Jun. 30, 2010, which claims the benefit of and priority to U.S. Provisional Patent Application No. 61/222,461, filed Jul. 1, 2009. The entire disclosures of International Patent Application No. PCT/US2010/040656 and U.S. Provisional Patent Application No. 61/222,461 are incorporated herein by reference.

### BACKGROUND

The present application relates generally to the field of batteries and battery systems. More specifically, the present application relates to batteries and battery systems that may be used in vehicle applications to provide at least a portion of the motive power for the vehicle, and which include an improved thermal management system.

Vehicles using electric power for all or a portion of their motive power (e.g., electric vehicles (EVs), hybrid electric vehicles (HEVs), plug-in hybrid electric vehicles (PHEVs), and the like, collectively referred to as “electric vehicles”) may provide a number of advantages as compared to more traditional gas-powered vehicles using internal combustion engines. For example, electric vehicles may produce fewer undesirable emission products and may exhibit greater fuel efficiency as compared to vehicles using internal combustion engines (and, in some cases, such vehicles may eliminate the use of gasoline entirely, as is the case of certain types of PHEVs).

As electric vehicle technology continues to evolve, there is a need to provide improved power sources (e.g., battery systems or modules) for such vehicles. For example, it is desirable to increase the distance that such vehicles may travel without the need to recharge the batteries. It is also desirable to improve the performance of such batteries and to reduce the cost associated with the battery systems.

One area of improvement that continues to develop is in the area of battery chemistry. Early electric vehicle systems employed nickel-metal-hydride (NiMH) batteries as a propulsion source. Over time, different additives and modifications have improved the performance, reliability, and utility of NiMH batteries.

More recently, manufacturers have begun to develop lithium-ion batteries that may be used in electric vehicles. There are several advantages associated with using lithium-ion batteries for vehicle applications. For example, lithium-ion batteries have a higher charge density and specific power than NiMH batteries. Stated another way, lithium-ion batteries may be smaller than NiMH batteries while storing the same amount of charge, which may allow for weight and space savings in the electric vehicle (or, alternatively, this feature may allow manufacturers to provide a greater amount of power for the vehicle without increasing the weight of the vehicle or the space taken up by the battery system).

It is generally known that lithium-ion batteries perform differently than NiMH batteries and may present design and engineering challenges that differ from those presented with NiMH battery technology. For example, lithium-ion batteries may be more susceptible to variations in battery temperature than comparable NiMH batteries, and thus systems may be used to regulate the temperatures of the lithium-ion batteries during vehicle operation. The manufacture of lithium-ion batteries also presents challenges unique to this battery chemistry, and new methods and systems are being developed to address such challenges.

It would be desirable to provide an improved battery module and/or system for use in electric vehicles that addresses one or more challenges associated with NiMH and/or lithium-ion battery systems used in such vehicles. It also would be desirable to provide a battery module and/or system that includes any one or more of the advantageous features that will be apparent from a review of the present disclosure.

### SUMMARY

An exemplary embodiment relates to a battery system for use in a vehicle that is configured to provide at least a portion of the propulsion power for the vehicle and includes a plurality of battery modules. Each battery module includes a plurality of electrochemical cells configured to store an electrical charge. The battery system also includes a plurality of fan assemblies each having a motor and at least one fan blade. Each fan assembly is associated with one of the plurality of battery modules to regulate the temperature thereof. A first fan assembly of the plurality of fan assemblies has a different configuration than at least one of the other of the plurality of fan assemblies or is configured to provide an output that is different from an output provided by at least one of the other of the plurality of fan assemblies.

An exemplary embodiment relates to a battery system for use in a vehicle that is configured to provide at least a portion of the propulsion power for the vehicle and includes a plurality of battery modules. Each battery module includes a plurality of electrochemical cells configured to store an electrical charge. The battery system also includes a first fan assembly associated with a first battery module of the plurality of battery modules. The first fan assembly includes a motor and at least one fan blade. The battery system also includes a second fan assembly associated with a second battery module of the plurality of battery modules. The second fan assembly includes a motor and at least one fan blade. The second fan assembly has a different configuration than the first fan assembly or is configured to provide an output that is different from an output provided by the first fan assembly.

### BRIEF DESCRIPTION OF THE DRAWINGS

FIG. 1 is a perspective view of a vehicle including a battery system according to an exemplary embodiment.

FIG. 2 is a cutaway schematic view of a vehicle including a battery system according to an exemplary embodiment.

FIG. 3 is a perspective view of a battery module according to an exemplary embodiment.

FIG. 3A is a top view of a battery module according to another exemplary embodiment.

FIG. 4 is a schematic of a battery system according to an exemplary embodiment.

FIG. 5 is a schematic of a battery system according to another exemplary embodiment.

FIG. 6 is a schematic of a battery system according to another exemplary embodiment.

FIG. 7 is a schematic of a battery system according to another exemplary embodiment.

FIGS. 8A, 8B, 8C, and 8D illustrate fan blades according to various exemplary embodiments.

FIG. 9 is a graph illustrating fan speed over time of a battery system including three fan assemblies, according to an exemplary embodiment.

FIG. 10 is a plot illustrating fan speed over time of a battery system including three fan assemblies, according to an exemplary embodiment.

### DETAILED DESCRIPTION

According to an exemplary embodiment, a battery system for use in a vehicle that is configured to provide at least a portion of the propulsion power for the vehicle and includes a plurality of battery modules. Each battery module including a plurality of electrochemical cells configured to store an electrical charge. The battery system also an improved thermal management system that includes a plurality of fan assemblies, where each of the fan assemblies includes a motor and at least one fan blade. Each fan assembly is associated with one of the plurality of battery modules to regulate the temperature thereof. A first fan assembly of the plurality of fan assemblies has a different configuration than at least one of the other of the plurality of fan assemblies or is configured to provide an output that is different from an output provided by at least one of the other of the plurality of fan assemblies (i.e., the first fan assembly can have a different configuration, it can provide a different output, or it can both have a different configuration and provide a different output than one or more other fan assemblies in the system). According to an exemplary embodiment, each of the fan assemblies in the battery system may differ from every other fan assembly in the system in one or more respects. According to another exemplary embodiment, one or more of the fan assemblies may have identical configurations and operate the same as one or more other fan assemblies in the system (e.g., two assemblies may be identical and two different assemblies may have a second different configuration).

One or more than one of the plurality of fan assemblies may have fan motors with a first configuration and one or more than one of the plurality of fan assemblies may have fan motors with a second different configuration. The plurality of fan motors may be configured to operate at variable speeds, such as sinusoidal speeds, which may be offset from the other variable speeds (e.g., sinusoidal speeds) of the plurality of fan motors by a phase angle shift. The one or more than one fan assembly having the fan motor with the first configuration may operate having a different output power than the one or more than one fan assembly having a fan motor with a second different configuration.

One or more than one of the plurality of fan assemblies may have fan blades with a first configuration and one or more than one of the plurality of fan assemblies may have fan blades with a second different configuration. One or more than one of the plurality of fan assemblies may have fan blades with a first configuration and fan motors with a first configuration, and one or more than one of the plurality of fan assemblies may have fan blades with a second different configuration and fan motors with a second different configuration.

A controller may be included that is configured to monitor and regulate the performance (e.g., speed, power, torque, etc.) of the plurality of fan assemblies. The controller may be configured to regulate the speed and/or the torques of the fan motors of the plurality of fan assemblies. The controller may be configured to regulate the performance of the plurality of fan assemblies in order to maintain similar operating temperatures between the plurality of battery modules of the battery system.

According to an exemplary embodiment, a battery system includes a plurality of battery modules. Each battery module includes a plurality of electrochemical cells arranged so that there is space (e.g., a channel or passage) between the cells that may be used to either heat or cool the cells. Each battery module also includes an associated thermal management device, such as a fan, to deliver a heating or cooling fluid to the battery module in order to heat or cool the cells within the battery module.

According to one exemplary embodiment, each of the thermal management devices differ from one another in one or more respects. The thermal management devices may differ in terms of the size of the motors, the size of the blades, the shape of the blades, and/or the angle of the blades. According to another exemplary embodiment, the thermal management devices use identical motors, but include different blade designs (e.g., size, shape, and/or angle of the blades) for each thermal management device. According to another exemplary embodiment, the thermal management devices are identical or may differ in terms of motors and blade designs, but operate at varied speeds that only overlap each other for small periods of time. According to another exemplary embodiment, the thermal management devices are controlled by a controller utilizing a look-up table containing mutually exclusive fan speeds.

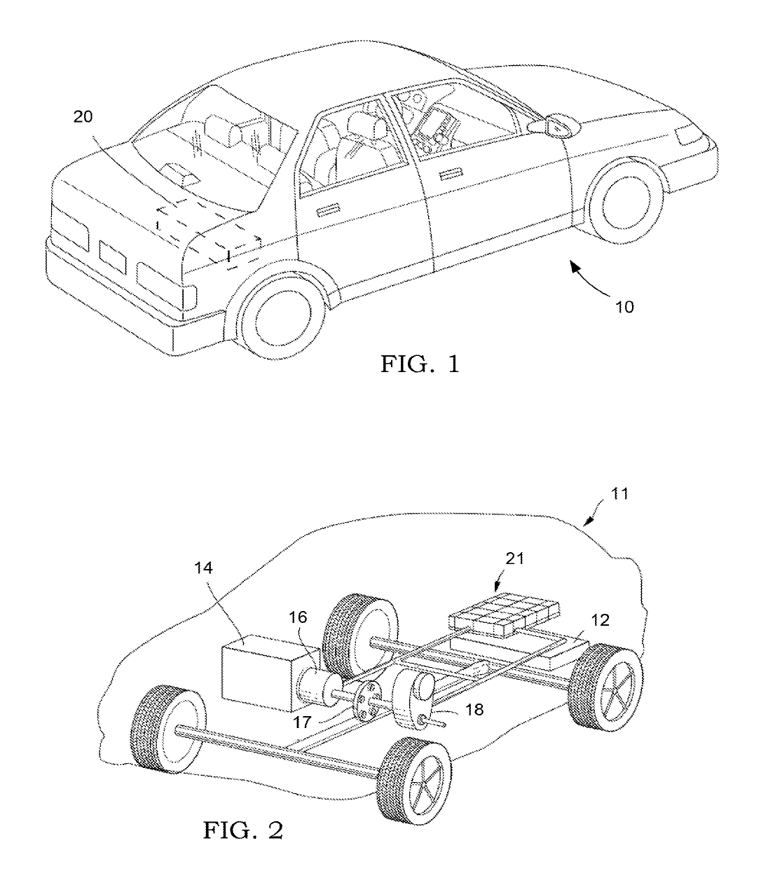

FIG. 1 is a perspective view of a vehicle 10 in the form of an automobile (e.g., a car) having a battery system 20 for providing all or a portion of the motive power for the vehicle. Such vehicles can be electric vehicles (EV), hybrid electric vehicles (HEV), plug-in hybrid electric vehicles (PHEV), or other types of vehicles using electric power for propulsion (collectively referred to as “electric vehicles”).

Although illustrated as a typical passenger car (e.g., sedan) in FIG. 1, the type of vehicle 10 may differ according to other exemplary embodiments, all of which are intended to fall within the scope of the present disclosure. For example, the vehicle may be a truck, bus, industrial vehicle, motorcycle, recreational vehicle, boat, or any other type of vehicle that may benefit from the use of electric power for all or a portion of its propulsion power.

Although the battery system 20 is illustrated in FIG. 1 as being positioned in the trunk or rear of the vehicle 10, according to other exemplary embodiments, the location of the battery system 20 may differ. For example, the position of the battery system 20 may be selected based on the available space within a vehicle, the desired weight balance of the vehicle, the location of other components used with the battery system 20 (e.g., battery management systems, vents or cooling devices, etc.), and a variety of other considerations.

FIG. 2 illustrates a cutaway schematic view of a vehicle 11 provided in the form of an HEV according to an exemplary embodiment. A battery system 21 is provided toward the rear of the vehicle 11 proximate a fuel tank 12 (the battery system 21 may be provided immediately adjacent the fuel tank or may be provided in a separate compartment in the rear of the vehicle 11 (e.g., a trunk) or may be provided elsewhere in the vehicle). An internal combustion engine 14 is provided for times when the HEV utilizes gasoline power to propel the vehicle 11. An electric motor 16, a power split device 17, and a generator 18 are also provided as part of the vehicle drive system. Such an HEV may be powered or driven by just the battery system 21, by just the engine 14, or by both the battery system 21 and the engine 14. It should be noted that other types of vehicles and configurations for the vehicle electrical system may be used according to other exemplary embodiments, and that the schematic illustration of FIG. 2 should not be considered to limit the scope of the subject matter described in the present application.

According to various exemplary embodiments, the size, shape, and location of the battery system 20, 21, the type of vehicle 10, 11, the type of vehicle technology (e.g., EV, HEV, PHEV, etc.), and the battery chemistry, among other features, may differ from those shown or described.

According to an exemplary embodiment, the battery system 20, 21 is responsible for packaging or containing one or more than one battery modules having one or more than one electrochemical cells or batteries, connecting the electrochemical cells to each other and/or to other components of the vehicle electrical system, and regulating the electrochemical cells and other features of the battery system 20, 21. For example, the battery system 20, 21 may include features that are responsible for monitoring and controlling the electrical performance of the battery system 20, 21, managing the thermal behavior of the battery system 20, 21, containment and/or routing of effluent (e.g., gases that may be vented from a battery cell), and other aspects of the battery system 20, 21.

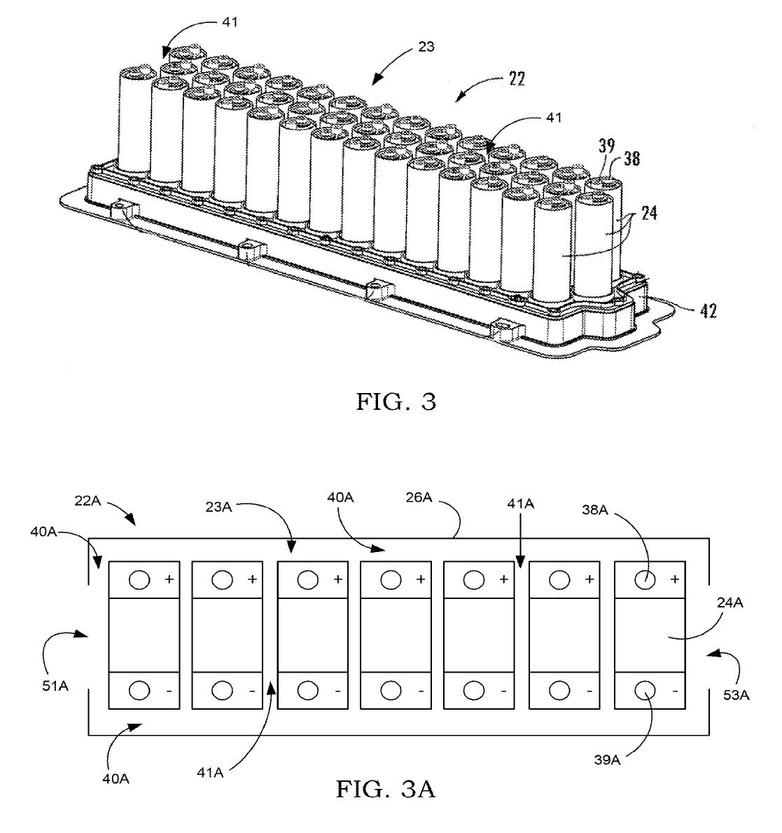

With reference to FIGS. 3 and 3A, exemplary embodiments of battery modules 22, 22A are shown for use in a battery system (e.g., such as for the battery systems 20, 21). According to the exemplary embodiment of FIG. 3, the battery module 22 includes a battery pack 23, a housing (not shown), and a member or tray 42. According to the exemplary embodiment shown in FIG. 3A, the battery module 22A includes a battery pack 23A and a housing 26A.

The battery packs 23, 23A may include a plurality of electrochemical cells or batteries 24, 24A. The number and arrangement of the cells may differ according to other exemplary embodiments. For example, although illustrated in FIG. 3 as having a particular number of electrochemical cells 24 (i.e., three rows of electrochemical cells arranged with fourteen cells in each row for a total of forty-two cells), it should be noted that according to other exemplary embodiments, a different number and/or arrangement of electrochemical cells 24 may be used in the battery pack 23 depending on a variety of considerations (e.g., the desired power for the battery module 22, the available space within which the battery pack 23 must fit, etc.). Similarly, the battery pack 23A illustrated in FIG. 3A has a total of 7 electrochemical cells 24A arranged in a single row. According to other exemplary embodiments, the battery pack 23A may include a plurality of layers of electrochemical cells 24A arranged in a single row, such that for three layers, the battery pack 23A would include twenty-one cells 24A.

According to the exemplary embodiment illustrated in FIG. 3, the electrochemical cells 24 are cylindrically shaped lithium-ion cells configured to store an electrical charge. According to the exemplary embodiment illustrated in FIG. 3A, the electrochemical cells 24A are prismatic lithium-ion cells configured to store an electrical charge. According to other exemplary embodiments, the cells may instead be nickel-metal-hydride cells, lithium-polymer cells, or any other type of electrochemical cells known or hereafter developed. The electrochemical cells may also have any physical configuration (e.g., cylindrical, oval, polygonal, etc.) and may also have varying capacity, size, and design from those electrochemical cells shown herein. It should be noted that the battery module may include any number of electromechanical cells arranged or aligned in any suitable manner, which may be tailored to accommodate various customer requirements (e.g., deliverable power, space constraints, rate capability, etc.).

Each electrochemical cell 24, 24A includes at least one negative electrode 38, 38A and at least one positive electrode 39, 39A. According to other exemplary embodiments, each electrochemical cell includes a plurality of negative electrodes and positive electrodes, which may be stacked in alternating fashion with separators provided between to provide isolation between adjacent positive and negative electrodes or configured in any suitable manner. The negative electrodes 38, 38A and the positive electrodes 39, 39A may be configured to have any suitable shape.

According to an exemplary embodiment, the tray 42 receives the individual electrochemical cells 24 in the proper orientation for assembling the battery pack 23 of the battery module 22. The tray 42 may include features (e.g., sockets, compartments, apertures, etc.) for providing the proper orientation or arrangement of cells 24, which may also provide space 41, 41A between two adjacent cells 24, 24A and/or from the cell 24 and the tray 42. The space 41, 41A allows for fluid to flow through the space 41, 41A, facilitating convection of the fluid across the cells 24, 24A. The socket may locate and hold the electrochemical cell 24 in the proper orientation, or may retain (or hold) only a portion (e.g., lower portion) of the electrochemical cell 24. Accordingly, the shape of the socket may be tailored to the shape of the cell. For example the socket may be circular or rectangular to accept cylindrical or prismatic cells, respectively.

The housing 26A of the battery module 22A may include a plurality of walls forming a substantially hollow polyhedron shape. According to an exemplary embodiment, the housing 26A includes five walls forming a substantially hollow hexahedron shape that is open on the bottom surface. It should be noted that the shape of the housing may be tailored to accommodate the shape of the battery pack and/or a tray, as well as any other feature or geometry of the battery module. The housing 26A is configured to substantially enclose the battery pack 23A to provide protection to the battery pack 23A and structural support to the battery module 22A. The housing 26A is configured to allow for space 40A between the walls of the housing 26A and electrochemical cells 24A in order to allow a fluid to flow through the space 40A to facilitate convection of the fluid across the electrochemical cells 24A.

The housing 26A further includes an inlet or opening 51A and an outlet or opening 53A. The inlet 51A is configured to be an aperture to allow fluid (e.g., air) to enter the battery module 22A, in order for the fluid to influence the temperature of the electrochemical cells 24A of the battery pack 23A by convection. The inlet 51A may be aligned with a fan assembly (such as will be described in more detail below) in order to maximize the flow rate of the fluid entering the battery module 22A. The outlet 53A is configured to be an aperture for allowing the fluid used to influence the temperature of the cells 24A of the battery pack 23A to exit the battery module 22A.

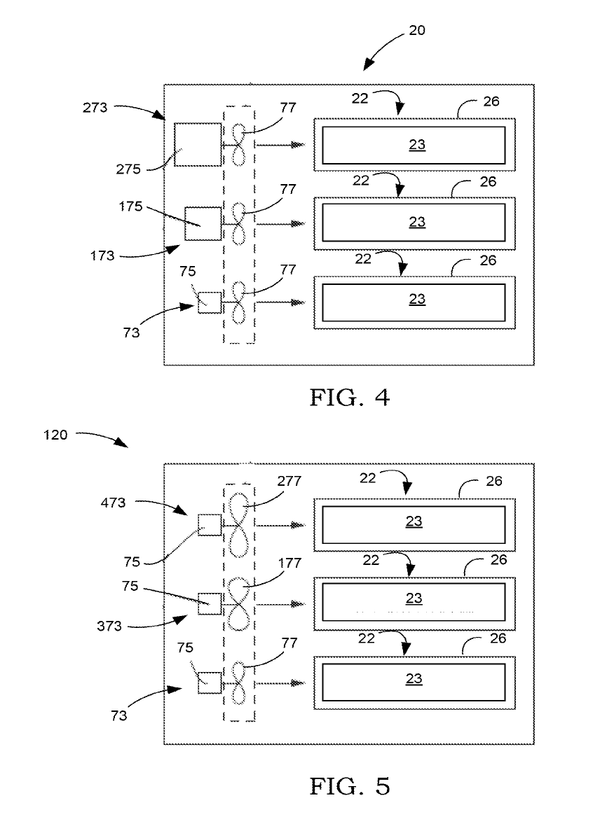

With reference to FIG. 4, an exemplary embodiment of a battery system 20 is shown to include three battery modules 22, a first fan assembly 73, a second fan assembly 173, and a third fan assembly 273. Each battery module 22 includes a battery pack 23 and a housing 26. The first fan assembly 73 includes a fan motor 75 and a fan blade 77. The first fan assembly 73 may regulate the temperature of a first battery module 22 through convection by generating forces to move a fluid (e.g., air) across the battery module. The second fan assembly 173 includes a fan motor 175 and a fan blade 77. The second fan assembly 173 may regulate the temperature of a second battery module 22 through convection by generating forces to move a fluid across the battery module. The third fan assembly 273 includes a fan motor 275 and a fan blade 77. The third fan assembly 273 may regulate the temperature of a third battery module 22 through convection by generating forces to move a fluid across the battery module.

The battery system 20 has fan assemblies 73, 173, 273 that include three different fan motors 75, 175, 275 and substantially similar fan blades 77 (although according to other exemplary embodiments, only one of the fan assemblies may differ from the others; depending on the number of battery modules and fan assemblies, any desired number of the fan assemblies may be configured differently than the others). The fan motors 75, 175, 275 may be configured to provide unique or different power outputs, speed outputs, torque outputs, and/or any performance parameter relative to the other fan motors in the battery system 20.

According to an exemplary embodiment, the fan motors 75, 175, 275 of the battery system 20 may have unique or different performance parameters that are tailored to optimize temperature regulation of the battery modules of the battery system while producing a minimal level (or amount) of output response (e.g., noise) for the combined system. For example, the output response (e.g., noise, noise amplitude) of each fan assembly may be tailored by the unique fan motors to create a destructive interference with the output response of the other fan assemblies of the battery system to reduce or eliminate the total output response (e.g., total noise amplitude) of the battery system. Thus, the output response of the individual fan assemblies may be configured to cancel or reduce the output response of the other fan assemblies, for example, to improve cooling of the battery modules while reducing noise, which typically is undesirable to occupants of the vehicle. Additionally, the performance parameters of the fan motors may be uniquely tailored to avoid resonance of the fan assembly and to avoid resonance of the battery system, thereby avoiding the high amplitude spikes that accompany resonance.

With reference to FIG. 5, another exemplary embodiment of a battery system 120 is shown to include three battery modules 22, a first fan assembly 73, a second fan assembly 373, and a third fan assembly 473. The battery module 22 includes a battery pack 23 and a housing 26. The first fan assembly 73 includes a fan motor 75 and a fan blade 77. The first fan assembly 73 may regulate the temperature of a first battery module 22 through convection by generating forces to move a fluid (e.g., air) across the battery module. The second fan assembly 373 includes a fan motor 75 and a fan blade 177. The second fan assembly 373 may regulate the temperature of a second battery module 22 through convection by generating forces to move a fluid across the battery module. The third fan assembly 473 includes a fan motor 75 and a fan blade 277. The third fan assembly 473 may regulate the temperature of a third battery module 22 through convection by generating forces to move a fluid across the battery module.

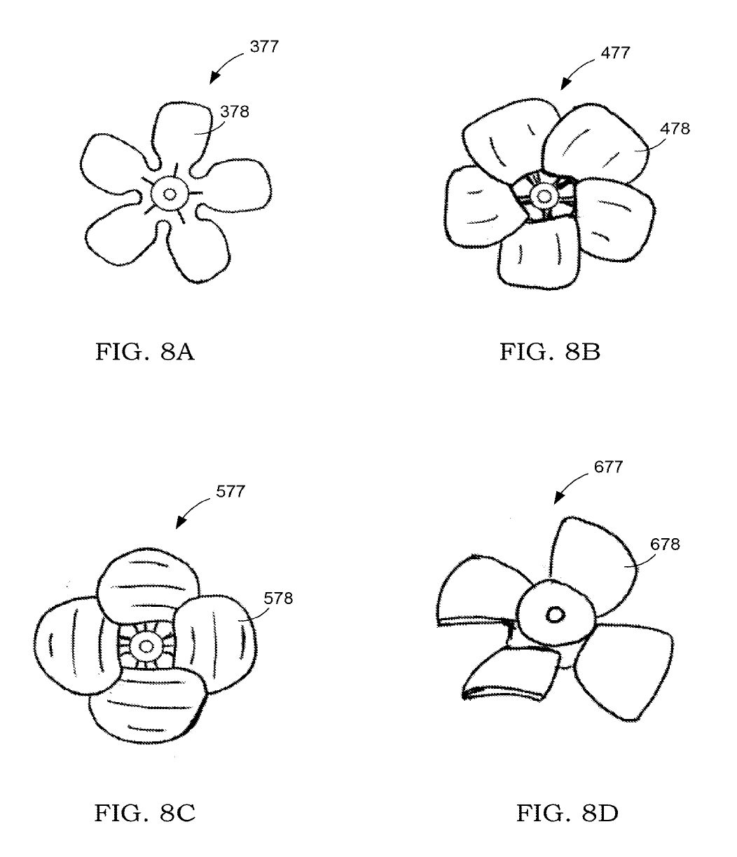

The battery system 120 may be configured to have fan assemblies 73, 373, 473 that include unique fan blades 77, 177, 277 and substantially similar fan motors 75 (although according to other exemplary embodiments, only one of the fan assemblies may differ from the others; depending on the number of battery modules and fan assemblies, any desired number of the fan assemblies may be configured differently than the others). The fan blades 77, 177, 277 may be configured to provide unique or different performance parameters (e.g., flow rate, frequency, etc.) or may be configured to have unique or different design parameters (e.g., number of vanes, pitch of vanes, vane shape or geometry, etc.) relative to the other fan blades in the battery system 120. For example, fan blade 77 may be configured to produce a different flow rate, such as in cubic feet per minute (cfm), relative to fan blade 177 and fan blade 277. As another example, fan blade 77 may be configured to produce the same flow rate as fan blades 177, 277, but may do so with a different output frequency relative to fan blades 177, 277. Nonexclusive examples of several different types of fan blades that may be used are illustrated in FIGS. 8A-8D, although other configurations may be used according to other exemplary embodiments.

According to an exemplary embodiment, the fan blades of the battery system may have unique or different performance or design parameters that are tailored to optimize temperature regulation of the battery modules of the battery system while producing a minimal level (or amount) of output (e.g., noise) for the combined system. For example, the output response (e.g., noise amplitude) of each fan assembly may be tailored by the unique fan blades to create a destructive interference with the output response of the other fan assemblies of the battery system to reduce or eliminate the total output response (e.g., total noise amplitude) of the battery system. Thus, the output response of the individual fan assemblies may be configured to cancel or reduce the output response of the other fan assemblies, for example, to improve cooling of the battery modules while reducing noise. Additionally, the fan blades may be uniquely tailored to avoid resonance of the fan assembly and to avoid resonance of the battery system, thereby avoiding the high amplitude spikes that accompany resonance.

The fan blades may have varying geometry to tailor the performance parameters, relative to other fan blades of the battery system in order for the battery system to provide optimal temperature control, while producing a minimal level of noise. According to the exemplary embodiments shown in FIGS. 8A and 8B, the fan blades 377, 477 may include five vanes 378, 478. According to the exemplary embodiments shown in FIGS. 8C and 8D, the fan blades 577, 677 may include four vanes 578, 678. According to other embodiments, the fan blades may include any number of vanes. The number of vanes may be varied to influence and/or tailor the performance parameters of the fan blades, such as flow rate and output frequency.

The geometry of the vanes 378, 478, 578, 678 may vary to influence and/or tailor the performance parameters of the fan blades 377, 477, 577, 677. According to an exemplary embodiment, the vanes 378 may have a substantially rectangular profile, may be substantially flat and aligned with an angle of pitch relative (e.g., 15 degrees, 20 degrees, 30 degrees, etc.) to the normal direction that the fan blade forces the fluid to flow along. According to another exemplary embodiment, the vanes 478 may have a substantially rectangular profile, may be concave/convex in shape and be aligned with an angle of pitch relative to the normal direction that the fan blade forces the fluid to flow along. According to another exemplary embodiment, the vanes 578 may have a mushroom shaped profile that is substantially flat and aligned at a pitch angle. According to other embodiments, the vanes may have any suitable profile (e.g., tear shaped), may have any suitable cross-sectional shape (e.g., uniform, foil, etc.), and may or may not be aligned at a pitch angle. It should be noted that other types of fan blade configurations may be used according to other embodiments, and those shown herein should not be considered to limit the scope of the subject matter described in the present application.

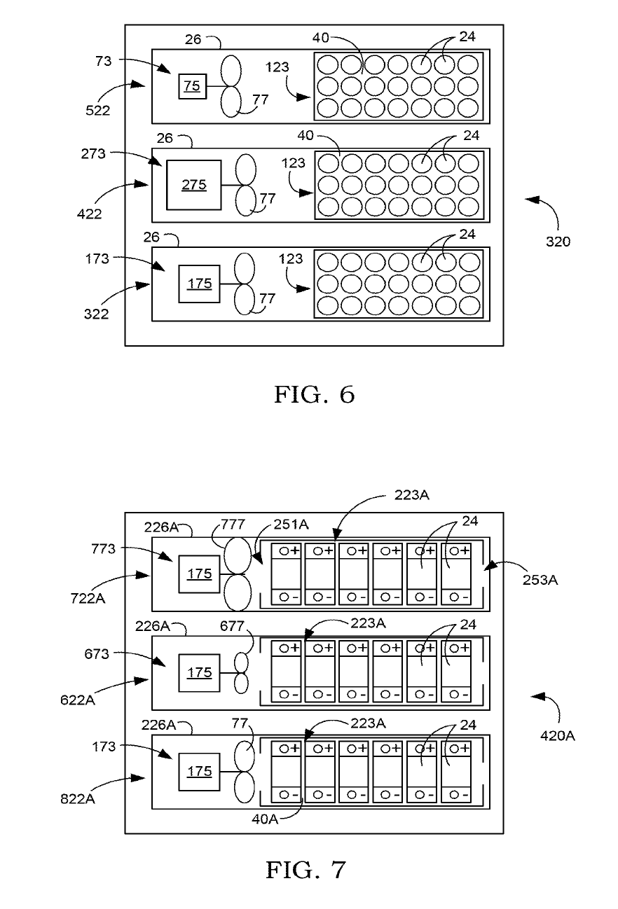

With reference to FIGS. 6 and 7, battery systems 320, 420A are shown to include battery modules having fan assemblies positioned or located within the battery modules of the battery system adjacent the battery packs. The fan assemblies include different motors but similar or identical fan blades. According to the exemplary embodiment shown in FIG. 6, the battery system 320 includes three battery modules 322, 422, 522 (cylindrical cells are shown included in the battery packs, although it should be understood to those reviewing the present application that, as described above, the configuration and arrangement of the cells may vary in any of the exemplary embodiments shown and described herein). According to other embodiments, the battery system may include any number of battery modules. The battery module 322 includes a fan assembly 173 configured to regulate the temperature of the battery pack 123 of the battery module 322 through convection. The fan assembly 173 is configured influence the temperature of the electrochemical cells 24 of the battery pack 123. The fan assembly 173 may include a fan motor 175 and a fan blade 77. The battery module 422 includes a fan assembly 273 configured to regulate the temperature of the battery pack 123 of the battery module 422 through convection. The fan assembly 273 may include a fan motor 275 and a fan blade 77. The battery module 522 includes a fan assembly 73 configured to regulate the temperature of the battery pack 123 of the battery module 522 through convection. The fan assembly 73 may include a fan motor 75 and a fan blade 77. Thus, the battery system 320 may be configured to include varying configured battery modules 322, 422, 522, which may include different fan motors providing different performance parameters, while having substantially similar fan blades 77. It should be noted that although the battery module 322, 422, 522 are shown to include substantially similar battery packs 123, each battery module may be configured to include a different battery module.

According to the exemplary embodiment shown in FIG. 7, the battery system 420A includes three battery modules 622A, 722A, 822A. As with FIG. 6, the fan assemblies are positioned or located within the battery module adjacent the battery packs, although here the motors of the fan assemblies are similar or identical and the configuration of the fan blades differ. The battery module 822A includes a fan assembly 173 configured to regulate the temperature of the battery pack 223A of the battery module 322 through convection. The fan assembly 173 is configured influence the temperature of the electrochemical cells 24A of the battery pack 223A. The fan assembly 173 includes a fan motor 175 and a fan blade 77. The battery module 622A includes a fan assembly 673 configured to regulate the temperature of the battery pack 223A of the battery module 622A through convection. The fan assembly 673 includes a fan motor 175 and a fan blade 677. The battery module 722A includes a fan assembly 773 configured to regulate the temperature of the battery pack 223A of the battery module 722A through convection. The fan assembly 773 may include a fan motor 175 and a fan blade 777. Thus, the battery system 420A may be configured to include varying configured battery modules 622A, 722A, 822A which may include different fan blades 77, 677, 777 providing different performance parameters, while having substantially similar fan motors 175.

It should be noted that the battery systems may also be configured to include battery modules having varying fan motors as well as varying fan blades relative to the other battery modules, and/or the battery systems may be configured to include fan assemblies having varying fan motors as well as varying fan blades. Thus, the configurations as shown herein should not be considered to limit the scope of the subject matter described in the present application.

Each of the battery modules as shown and described herein includes a single fan assembly to aid in regulating the temperature of the battery pack and/or battery module. However, according to other exemplary embodiments, the battery module may include a plurality of fan assemblies. For example, battery modules with especially high power loads (with a corresponding high level of waste heat produced) or multiple modules, the battery system may include a plurality of fan assemblies or other thermal management devices to provide the necessary cooling. The multiple fans may each provide a heating or cooling fluid (e.g., air) to a separate battery pack (or battery module) or may all be used to provide a heating or cooling fluid for a single battery pack or module.

When two or more similar fan assemblies are operated in the battery module or in the battery system at the same time, the similar fans may oscillate such that they resonate with each other or all together, causing a higher level of noise, which typically is undesirable to vehicle occupants. To reduce the level or amount of noise produced by the battery system, the characteristics or performance parameters of the fan assemblies may be altered or uniquely tailored so they avoid resonance individually or as a system, and therefore, avoid large amplitudes, such as amplitudes of oscillation. Additionally, when a plurality of similar fan assemblies operate simultaneously, each may produce an output response, such as sound or noise, that is substantially similar. According to the superposition principle, each output response may combine to produce a total output response that is the summation of the individual output responses. Thus, the battery systems disclosed herein may be tailored based on the superposition principle to reduce the total output response, thereby reducing the total level of noise the battery system may produce.

According to an exemplary embodiment, a battery system may include a controller to actively monitor and modify the operating characteristics of the plurality of fan assemblies to optimize temperature regulation while minimizing noise. According to another exemplary embodiment, rather than providing a controller to actively monitor and modify the operating characteristics of the various fans, several passive systems may be used to control the fans.

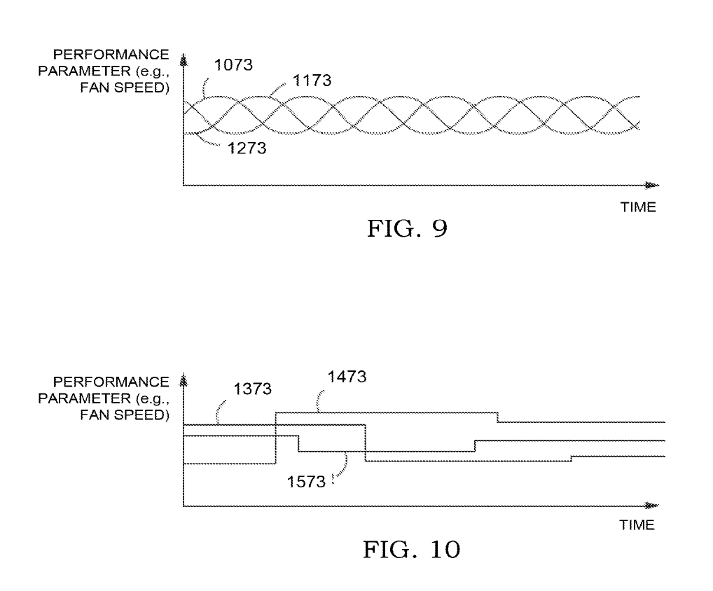

With reference to FIGS. 9-10, the battery system may be configured to alter the performance parameters (e.g., speeds) of the fans over time, such as by offsetting the performance parameters of multiple fans, in order to reduce or avoid resonance, as well as to reduce the amplitude of the total system output response, such as by generating destructive interference between the performance parameters. The battery system may include fan assemblies that are similarly configured or differently configured. For example the battery system may include a plurality of similarly configured fan assemblies that are controlled, such as by a controller, to operate with different performance parameters.

As shown in FIG. 9, a battery system includes three fans 1073, 1173, 1273 that operate having oscillating speeds (i.e., the speeds may be configured to vary with respect to time, such as being sinusoidal). The operating speeds of fans 1073, 1173, 1273 may have similar amplitudes and frequencies, however, fan 1173 may be out of phase (e.g., 120° out of phase) with fan 1273 and fan 1073, and fan 1273 may be may be out of phase (e.g., 120° out of phase) with fan 1273 and fan 1073. The battery system having this configuration provides for a substantially similar amount of temperature regulation by the three fans 1073, 1173, 1273, since a substantially similar flow rate may be produced by each fan, yet the noise for the combined system can be reduced relative to three fans operating at constant speeds. According to other exemplary embodiments, the performance parameters of the fans may be out-of-phase with one another more or less than 120°.

While the fans in FIG. 9 are shown as oscillating substantially in the shape of a sine wave, it should be noted that the speeds of the fans may be otherwise varied (e.g., a sawtooth wave, a square wave, etc.) or varied in some other manner. Additionally, the fans may operate at different or varying frequencies or may have varying or different amplitudes relative to the other fans.

As shown in FIG. 10, a battery system includes three fans 1373, 1473, 1573 that operate at constant speeds for segments of time, whereby the speed of each fan may be changed at certain times (that may be similar or different times relative to the other fans) to run at a different constant speed for another segment of time, and so forth. The system may include a controller to control the operating performance parameters (e.g., speed) of the fans 1373, 1473, 1573. The controller may utilize unique, non-overlapping (or overlapping) look-up tables (i.e., precalculated or predetermined arrays of data) to determine the speed with respect to time for each fan. The tables may determine the duration for which each fan operates at a given speed.

According to the exemplary embodiment illustrated in FIG. 10, the fan 1473 may initially operate at a constant fan speed that is less than the constant speeds of fans 1373, 1573, while fan 1573 may initially operate at a constant fan speed less than the constant speed of fan 1373. At a first time, the speed of fan 1473 may increase to a second constant speed that is greater than the initial constant speed of fan 1373. At a second time, the speed of fan 1573 may be reduced to a second constant speed to minimize the output response (e.g., noise) of the complete system and to avoid resonance. At a third time, the speed of fan 1373 may be reduced to a second constant speed that is less than the second constant speed of fan 1573 to further minimize the output response of the complete system and to avoid resonance. The speeds of the fans may be changed to maintain substantially similar operating temperatures of the battery modules or packs. Further, the speeds of fans 1373, 1473, 1573 may continue to be changed with respect to time in order to maintain substantially similar operating temperatures of the battery modules or packs being influenced by the respective fans, while avoiding resonance and minimizing the output response of the complete system.

According to another exemplary embodiment, the battery system may monitor the temperature of the individual battery modules or battery packs and may adjust the fan speeds to aid in maintaining the individual battery modules or packs at substantially similar operating temperatures. For example, if the first battery module is operating at a higher temperature relative to the operating temperature of the second battery module, the battery system may reduce the fan speed of the fan motor blowing fluid across the first battery module and may increase the fan speed of the fan motor blowing fluid across the second battery module. Thus, the operating temperature of the first may be reduced to be substantially similar to the operating temperature of the second battery module, while resonance is avoided and the noise output for the complete system is reduced or maintained at a substantially uniform level. The controller may change the fan speeds to aid in maintaining the cells of the individual battery modules or packs at similar operating temperatures while avoiding resonance and minimizing noise output for the complete system.

According to another exemplary embodiment, the battery system may include fans that are identical in terms of motors and blade designs, but operate at varied speeds that only overlap each other for small periods of time. According to another exemplary embodiment, the fans are controlled by a controller utilizing a single look-up table containing mutually exclusive fan speeds. According to another exemplary embodiment, the battery system may utilize fan motors having varying performance parameters and/or fan blades having different configurations, as well as having a controller to vary the performance parameters of the different fan motors over time to avoid resonance.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the battery pack apparatus as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A battery system for use in a vehicle that is configured to provide at least a portion of the propulsion power for the vehicle, the battery system comprising:
a plurality of battery modules, each battery module including a plurality of electrochemical cells configured to store an electrical charge; and
a plurality of fan assemblies each comprising a motor and at least one fan blade;
wherein each fan assembly is associated with one of the plurality of battery modules to regulate the temperature thereof; and
wherein a first fan assembly of the plurality of fan assemblies has a different configuration than at least one of the other of the plurality of fan assemblies or is configured to provide an output that is different from an output provided by at least one of the other of the plurality of fan assemblies.

2. The battery system of claim 1, wherein the first fan assembly is configured to reduce the total noise level generated by the plurality of fan assemblies by canceling out at least a portion of the noise generated by at least one other fan assembly.

3. The battery system of claim 1, wherein the first fan assembly is configured to reduce a noise level generated by the plurality of fan assemblies by avoiding a resonant frequency.

4. The battery system of claim 1, wherein the motor of the first fan assembly differs from a motor of at least one of the other of the plurality of fan assemblies.

5. The battery system of claim 1, wherein the motors of each of the plurality of fan assemblies are configured to operate at variable speeds.

6. The battery system of claim 5, wherein the motors of each of the plurality of fan assemblies are configured to operate at variable speeds such that the fan speed varies in a continuous sinusoidal manner.

7. The battery system of claim 6, wherein the first fan assembly is configured to operate at a speed that varies in a first sinusoidal manner and a second fan assembly of the plurality of fan assemblies is configured to operate at a speed that varies in a second sinusoidal manner that is offset from the first sinusoidal manner such that the speed of the first fan assembly is out of phase with the speed of the second fan assembly.

8. The battery system of claim 4, wherein the motor of the first fan assembly operates with a different power output than a motor of another of the plurality of fan assemblies.

9. The battery system of claim 1, wherein the first fan assembly has a fan blade configuration that differs from a fan blade configuration of at least one of the other of the plurality of fan blade assemblies.

10. The battery system of claim 9, wherein the first fan assembly has a motor configuration that differs from a motor configuration of at least one of the other of the plurality of fan blade assemblies.

11. The battery system of claim 1, wherein one or more of the plurality of fan assemblies have fan blades with a first configuration and fan motors with a first configuration, and one or more than one of the plurality of fan assemblies have fan blades with a second different configuration and fan motors with a second different configuration.

12. The battery system of claim 1, further comprising a controller that is configured to monitor and regulate the performance of the plurality of fan assemblies.

13. The battery system of claim 13, wherein the controller is configured to regulate the speeds of the motors of the plurality of fan assemblies.

14. The battery system of claim 13, wherein the controller is configured to regulate the torques of the motors of the plurality of fan assemblies.

15. The battery system of claim 13, wherein the controller regulates the performance of the plurality of fan assemblies in order to maintain similar operating temperatures between the plurality of battery modules.

16. A battery system for use in a vehicle that is configured to provide at least a portion of the propulsion power for the vehicle, the battery system comprising:
a plurality of battery modules, each battery module comprising a plurality of electrochemical cells configured to store an electrical charge;
a first fan assembly associated with a first battery module of the plurality of battery modules and comprising a motor and at least one fan blade; and
a second fan assembly associated with a second battery module of the plurality of battery modules and comprising a motor and at least one fan blade, wherein the second fan assembly has a different configuration than the first fan assembly or is configured to provide an output that is different from an output provided by the first fan assembly.

17. The battery system of claim 16, wherein the second fan assembly is configured to reduce the total noise level generated by first and second fan assemblies by canceling out at least a portion of the noise generated by the first fan assembly.

18. The battery system of claim 16, wherein the second fan assembly is configured to reduce a noise level generated by the plurality of fan assemblies by avoiding a resonant frequency.

19. The battery system of claim 16, wherein the motor of the second fan assembly differs from the motor of the first fan assembly.

20. The battery system of claim 16, wherein the motors of each of the first and second fan assemblies are configured to operate at variable speeds.
